(19) United States
(12) Patent Application Publication
(10) Pub. No.: US 2026/0212888 A1
(43) Pub. Date: Jul. 23, 2026

(54) SUPER-RESOLUTION THREE-DIMENSIONAL OPTICAL STORAGE FOCUSING SERVO DEVICE AND METHOD THEREOF

(71) Applicant: Shanghai Institute of Optics and Fine Mechanics, Chinese Academy of Sciences, Shanghai (CN)

(72) Inventors: Qiao HU, Shanghai (CN); Hao RUAN, Shanghai (CN); Miao ZHAO, Shanghai (CN); Jingwei ZHANG, Shanghai (CN)

(21) Appl. No.: 19/566,959

(22) Filed: Mar. 13, 2026

Related U.S. Application Data
(63) Continuation of application No. PCT/CN2025/096306, filed on May 21, 2025.

(30) Foreign Application Priority Data
Jan. 21, 2025 (CN) 202510089365.4

(51) Int. Cl. G11B 7/0045; G11B 7/00

(52) U.S. Cl. CPC G11B 7/0045; G11B 2007/0009

(57) ABSTRACT

A super-resolution three-dimensional optical storage focusing servo device and servo method thereof are provided. The device integrates a light source shaping module, a beam combining module, a zoom layer-selection module, a servo signal detection module, and a drive control module. A coaxial recording beam is formed by combining a solid excitation beam and a hollow inhibition beam, and signals generated by reflection of the solid servo beam from the servo guiding layer are utilized to control the axial movement of the servo objective lens and the recording objective lens. During reading and writing processes, the centers of the dual beams remain consistently aligned, enabling high-speed nanoscale focusing servo.

### CROSS-REFERENCE TO RELATED APPLICATIONS

The subject application is a continuation of PCT/CN2025/096306 filed on May 21, 2025, which in turn claims priority on Chinese Patent Application No. CN 202510089365.4 filed on Jan. 21, 2025 in China. The contents and subject matters of the PCT international application and the Chinese priority application are incorporated herein by reference.

### TECHNICAL FIELD

The present invention relates to the field of optical storage, particularly to super-resolution three-dimensional (3D) optical storage, which provides a solution and device structure addressing the issue of multi-layer focusing servo in super-resolution 3D optical storage.

### BACKGROUND ART

In the era of big data, data have become a production factor as crucial as land, capital, and labor. With the rapid development of technologies such as artificial intelligence, the metaverse, the digital economy, and quantum computing, emerging application scenarios have raised higher demands for data storage in terms of security, capacity, and efficiency. Particularly in industries such as military, judicial administration, archives, healthcare, and finance, a vast amount of sensitive data require long-term, or even permanent, tamper-proof preservation. Optical storage technology, based on non-contact and offline read-write principles, offers advantages such as high security and reliability, ultra-low power consumption, and long lifespan (>50 years), making it highly suitable for the long-term storage of massive data. However, traditional optical storage technology is constrained by the optical diffraction limit and relies on reflection-based read-write mechanisms, limiting commercial Blu-ray discs to a storage capacity of only around the hundred-gigabyte level with a maximum of three layers per side. The limit significantly hinders the widespread application of optical storage technology and related products in the big data market. To enhance storage capacity, researchers worldwide have explored approaches such as multi-layer storage, multi-dimensional storage, multi-wavelength multi-level storage, and holographic storage. Nevertheless, these technologies fundamentally fail to overcome the diffraction limit, and none have achieved a truly milestone breakthrough in storage capacity. Moreover, their high costs make large-scale industrialization challenging.

In recent years, researchers have been dedicated to developing super-resolution 3D optical storage technologies that break through the optical diffraction limit. Among them, the dual-beam modulation aggregation-induced emission super-resolution optical storage technology, based on the dual-beam super-resolution principle, builds upon traditional single-beam solid excitation light for reading and writing. By introducing a second hollow inhibition beam, it modulates the effective range of the first solid excitation beam. The technology leverages the contrast in fluorescence between the central region and the surrounding area of the focal spot to record information, forming information recording points smaller than the diffraction limit and achieves ultra-high-density storage, enabling multi-layer recording of up to hundreds of layers. A single disc has the potential to reach petabit-scale capacity (see Nature, 2024, 626: 772-778).

However, breaking the diffraction limit does not signify the full arrival of next-generation optical storage technology. On the path toward industrialization, numerous challenges remain to be addressed. Firstly, unlike traditional commercial optical storage devices, super-resolution 3D optical storage systems employ dual beams for information recording. One solid excitation beam interacts with the material to form information points, while the other hollow inhibition beam (with zero intensity at its center) suppresses the formation of information points, ultimately creating nanoscale information points that surpass the diffraction limit. Therefore, during both writing and reading processes, the solid excitation beam and the hollow inhibition beam must maintain precise 3D alignment. Existing focusing servo systems, which only account for single-beam tracking and compensation, are inadequate for super-resolution 3D optical storage systems, necessitating the development of compatible focusing servo devices. Secondly, to achieve ultra-high-density multi-layer storage, the recording media in super-resolution 3D optical storage systems exhibit exceptionally high transparency. Unlike traditional commercial optical storage systems that rely on reflected light for reading, super-resolution 3D optical storage systems utilize fluorescence-based reading. During high-speed disc rotation, challenges such as rapid layer positioning and zoom focusing arise. These issues impose stringent demands on the focusing servo control system of super-resolution 3D optical storage systems. Current servo solutions for such systems typically introduce an additional dedicated servo beam, as seen in patents such as CN109524029B. Combined with the dual beams for reading and writing, the entire optical system requires three lasers of different wavelengths, each requiring separate control, which results in system complexity and significant challenges in integration. Moreover, the focusing servo system in such configurations cannot monitor or compensate for the alignment of the centers of the solid excitation beam and the hollow inhibition beam. Once the focal deviation between the dual beams exceeds a certain range (typically tens of nanometers), the super-resolution recording effect cannot be achieved, rendering the servo system ineffective. Consequently, there is an urgent need to develop a high-precision, structurally simple, and highly integrated focusing servo device and corresponding control method specifically for super-resolution 3D optical storage.

### SUMMARY OF THE INVENTION

To address the shortcomings of existing technologies, the present invention provides a super-resolution 3D optical storage focusing servo device and its servo method capable of precisely executing multi-layer focusing servo during the reading and writing processes of super-resolution 3D optical storage media.

To achieve the above and other related objectives, the present invention provides a super-resolution 3D optical storage focusing servo device, comprising:
a light source shaping module, configured to generate a solid excitation beam, a hollow inhibition beam, and a solid servo beam;
a beam combining module, configured to combine the solid excitation beam and the hollow inhibition beam into a coaxial recording beam with coincident centers;
a zoom layer-selection module, configured to control the axial position of the focused spot of the coaxial recording beam and the axial position of the focused spot of the solid servo beam;
a servo signal detection module, configured to receive the reflected servo beam generated by the reflection of the solid servo beam from a servo guiding layer and convert it into a servo reflection signal for monitoring;
a recording signal detection module, configured to detect the fluorescence signal generated by the coaxial recording beam in an information recording layer;
a drive control module, configured to receive the servo reflection signal and the fluorescence signal, drive the beam combining module to perform aberration compensation on the solid excitation beam and the hollow inhibition beam based on the fluorescence signal until their focal centers are aligned, and drive the objective lens in the zoom layer-selection module to move axially based on the servo reflection signal, so as to focus the solid servo beam onto the servo guiding layer of the optical storage medium and focus the coaxial recording beam onto the selected information recording layer of the optical storage medium.

In one embodiment of the present invention, the zoom layer-selection module comprises a recording objective lens and a servo objective lens. The recording objective lens is configured to control the axial position of the focused spot of the coaxial recording beam, while the servo objective lens is configured to control the axial position of the focused spot of the solid servo beam. The axial movement of the servo objective lens can drive or trigger the corresponding axial movement of the recording objective lens in a timely manner. The drive control module drives the servo objective lens to move axially based on the servo reflection signal, while simultaneously driving or triggering the axial movement of the recording objective lens.

Preferably, the recording objective lens and the servo objective lens are rigidly connected to maintain stable relative positioning between them, thereby achieving more precise focus tracking servo.

Furthermore, the connection between the recording objective lens and the servo objective lens is not limited to rigid connection. As long as the recording objective lens can promptly perform corresponding axial movement in response to the motion of the servo objective lens to achieve the function of focus tracking servo, other forms of connected or non-connected synchronized movement mechanisms may be adopted.

Preferably, the numerical aperture of the objective lens in the zoom layer-selection module is not less than 0.65.

In the present invention, the term “axial” refers to the direction of the optical axis.

The optical storage medium has a multi-layer structure, comprising multiple information recording layers and one servo guiding layer containing spiral grooves. Preferably, the components of the information recording layer comprise a photoinitiator, a monomer, a metal ion compound, and an aggregation-induced emission dye.

In one embodiment of the present invention, the light source shaping module comprises a light source unit and a shaping unit. The light source unit emits laser light, which is split and shaped by the shaping unit to generate a solid excitation beam, a hollow inhibition beam, and a solid servo beam. Preferably, the light source unit comprises at least a single-wavelength laser source or laser sources of different wavelengths, emitting two incident laser beams into the shaping unit. The shaping unit splits and shapes the two incident laser beams to produce one solid excitation beam, one hollow inhibition beam, and one solid servo beam.

Preferably, the solid servo beam has the same wavelength as the solid excitation beam or the hollow inhibition beam. According to a specific embodiment of the present invention, the solid servo beam shares the same laser source with the solid excitation beam or with the hollow inhibition beam.

In one embodiment of the present invention, the shaping unit comprises a beam splitter, a collimating lens group, and a phase plate. The beam splitter is configured to split one incident laser beam into at least two optical paths. The collimating lens group is configured to collimate the beams in each optical path. The phase plate is configured to perform phase modulation on one collimated beam to form a hollow inhibition beam.

The beam combining module comprises a dichroic mirror, which is configured to combine beams from different optical paths into a common optical path.

The zoom layer-selection module comprises a compensating lens and an objective lens. The compensating lens is configured to perform focusing adjustments on the beams in each optical path, and the objective lens is configured to adjust the axial position of the focused spot of the beams in each optical path.

The drive control module comprises a displacement actuator and a controller. The controller is configured to receive signals and send commands to the displacement actuator, which drives the zoom layer-selection module and/or the beam combining module to perform precise adjustments according to the commands.

The recording signal detection module comprises a first filter and a first photodetector. The first filter is configured to filter out light of specific unwanted wavelengths to ensure the purity of the fluorescence signal, while the first photodetector is configured to detect the filtered fluorescence signal. The servo signal detection module comprises a second filter, an astigmatic lens, and a second photodetector. The second filter is configured to filter out specific unwanted wavelengths from the reflected servo light. The astigmatic lens modulates the reflected servo light such that when the focused spot of the coaxial recording beam is either on or off the selected information recording layer, the spot shape formed on the second photodetector differs. The second photodetector detects the reflected servo light after passing through the second filter and the astigmatic lens and converts it into a servo reflection signal for monitoring.

In one embodiment of the present invention, the light source unit comprises a first light source and a second light source. The shaping unit comprises a first collimating lens, a second collimating lens, a beam splitter, a half-wave plate, a first quarter-wave plate, a phase plate, a first reflector, and a polarizing beam splitter. The beam combining module comprises a first focusing lens, a first compensating lens, a first dichroic mirror, a second dichroic mirror, a second focusing lens, a second compensating lens, and a second reflector. The zoom layer-selection module comprises a third focusing lens, a third compensating lens, a recording objective lens, a fourth focusing lens, a fourth compensating lens, a second quarter-wave plate, and a servo objective lens. The drive control module comprises a controller, a first displacement actuator, a second displacement actuator, a third displacement actuator, a fourth displacement actuator, and a fifth displacement actuator. The servo signal detection module comprises a second filter, an astigmatic lens, a second optical fiber, and a second photodetector.

The beam emitted by the first light source passes through the first collimating lens to form a solid excitation beam. The beam emitted by the second light source enters the beam splitter via the second collimating lens, producing a first transmitted beam and a second transmitted beam. The first transmitted beam sequentially passes through the half-wave plate and the first quarter-wave plate before entering the phase plate, forming a hollow inhibition beam with a first circular polarization state. The second transmitted beam enters the polarizing beam splitter via the first reflector and is transmitted through the polarizing beam splitter to form a solid servo beam with a first linear polarization state. The solid excitation beam sequentially passes through the first focusing lens and the first compensating lens before entering the first dichroic mirror, where it is reflected as a first reflected beam and then enters the second dichroic mirror. After transmission through the second dichroic mirror, it forms a third transmitted beam. The hollow inhibition beam sequentially passes through the second focusing lens and the second compensating lens before entering the second dichroic mirror, where it is reflected as a second reflected beam. The second reflected beam and the third transmitted beam are combined by the second dichroic mirror and then reflected by the second reflector to form a third reflected beam. The third reflected beam sequentially passes through the third focusing lens, the third compensating lens, and the recording objective lens, and is incident on the M-th information recording layer of the optical storage medium, where it excites a fluorescence signal in the focused region. The solid servo beam sequentially passes through the fourth focusing lens and the fourth compensating lens before entering the second quarter-wave plate, where it is converted into a fourth transmitted beam with a second circular polarization state. The fourth transmitted beam passes through the servo objective lens and is incident on the servo guiding layer of the optical storage medium. After reflection by the servo guiding layer, it forms a fourth reflected beam with a third circular polarization state. The fourth reflected beam passes through the servo objective lens and enters the second quarter-wave plate, where it is converted by the second quarter-wave plate into a fifth transmitted beam with a second linear polarization state. The fifth transmitted beam sequentially passes through the fourth compensating lens and the fourth focusing lens before entering the polarizing beam splitter, where it is reflected as a fifth reflected beam. The fifth reflected beam sequentially passes through the second filter, the astigmatic lens, and the second optical fiber to reach the second photodetector, where it is converted into a servo reflection signal. The second photodetector is connected to the controller, monitors the servo reflection signal, and sends it to the controller. Based on the received servo reflection signal, the controller real-time controls the third displacement actuator to drive the third compensating lens for axial movement, the fourth displacement actuator to drive the fourth compensating lens for axial movement, and the fifth displacement actuator to drive the recording objective lens and the servo objective lens for coordinated axial movement.

In one embodiment of the present invention, the recording signal control module comprises a first filter, a fifth focusing lens, a first optical fiber, and a first photodetector. The fluorescence signal collected by the recording objective lens sequentially passes through the third compensating lens and the third focusing lens before being incident on the second reflector, where it is reflected as a sixth reflected beam. The sixth reflected beam sequentially passes through the second dichroic mirror, the first dichroic mirror, the first filter, the fifth focusing lens, and the first optical fiber to reach the first photodetector. The first filter transmits the fluorescence signal while filtering out the solid excitation beam and the hollow inhibition beam. The first photodetector is connected to the controller, detects the fluorescence signal, and sends it to the controller. Based on the received fluorescence signal, the controller controls the first displacement actuator to drive the first compensating lens for axial movement and the second displacement actuator to drive the second compensating lens for axial movement.

Preferably, the first linear polarization state and the second linear polarization state are mutually perpendicular.

Furthermore, the focusing servo device further comprises a spindle motor for controlling high-speed rotation of the optical storage medium. The drive control module controls the rotational speed of the spindle motor based on the received servo reflection signal or fluorescence signal.

The present invention also provides a 3D optical storage focusing servo method based on the aforementioned focusing servo device, comprising the following steps:
forming a solid excitation beam, a hollow inhibition beam, and a solid servo beam using a light source shaping module;
combining the solid excitation beam and the hollow inhibition beam into a coaxial recording beam with coincident centers using a beam combining module;
focusing the coaxial recording beam and the solid servo beam onto the M-th information recording layer and the servo guiding layer of the optical storage medium, respectively, using a zoom layer-selection module, where M is an integer;
monitoring, using a servo signal detection module, the servo reflection signal generated by the reflection of the solid servo beam from the servo guiding layer and transmitting it to the drive control module;
if the servo reflection signal is not within a set range, driving, by the drive control module based on the servo reflection signal, the recording objective lens and the servo objective lens of the zoom layer-selection module to move axially together until the servo reflection signal monitored by the servo signal detection module falls within the set range, thereby re-focusing the solid servo beam onto the servo guiding layer of the optical storage medium and re-focusing the coaxial recording beam onto the M-th information recording layer of the optical storage medium; wherein the recording objective lens is configured to control the axial position of the focused spot of the coaxial recording beam, and the servo objective lens is configured to control the axial position of the focused spot of the solid servo beam;
detecting, by a recording signal detection module, the fluorescence signal generated by the coaxial recording beam in the information recording layer and transmitting it to the drive control module; if there is an offset between the focal centers of the solid excitation beam and the hollow inhibition beam, the drive control module drives the beam combining module to perform aberration compensation on the solid excitation beam and the hollow inhibition beam based on the fluorescence signal until their focal centers are aligned; wherein the fluorescence signal serves as a feedback signal to indicate whether an offset exists between the focal centers of the solid excitation beam and the hollow inhibition beam.

In one embodiment of the present invention, the drive control module comprises a controller, a first displacement actuator, and a second displacement actuator. The controller, based on the received fluorescence signal, controls the first displacement actuator to drive the first compensating lens of the beam combining module for axial movement and the second displacement actuator to drive the second compensating lens of the beam combining module for axial movement. Herein, aberration compensation for the solid excitation beam is achieved through axial movement of the first compensating lens, and aberration compensation for the hollow inhibition beam is achieved through axial movement of the second compensating lens.

In one embodiment of the present invention, after receiving a zoom layer-jump request, the drive control module drives the third compensating lens of the zoom layer-selection module for axial movement and drives the recording objective lens and the servo objective lens for coordinated axial movement, thereby moving the focal points of the solid excitation beam and the hollow inhibition beam to the N-th information recording layer. Subsequently, it drives the fourth compensating lens of the zoom layer-selection module for axial movement to restore the focal point of the solid servo beam to the servo guiding layer. Herein, N is an integer, and N is not M.

In one embodiment of the present invention, the drive control module comprises a controller, a third displacement actuator, a fourth displacement actuator, and a fifth displacement actuator. After receiving a zoom layer-jump request, the controller outputs pre-set constant bias voltages to the third, fourth, and fifth displacement actuators, respectively. The third displacement actuator drives the third compensating lens for axial movement, and the fifth displacement actuator drives the recording objective lens and the servo objective lens for coordinated axial movement, thereby moving the focal points of the solid excitation beam and the hollow inhibition beam to the N-th information recording layer. Subsequently, the fourth displacement actuator drives the fourth compensating lens for axial movement to restore the focal point of the solid servo beam to the servo guiding layer.

As described above, the super-resolution 3D optical storage focusing servo device and its servo method of the present invention offer the following beneficial effects:
(1) During the read/write process, the focal points of the solid excitation beam and the hollow inhibition beam can be adjusted in real time through the servo reflection signal and fluorescence signal for focus control. This ensures that the dual beams remain three-dimensionally aligned and focused on the selected information recording layer at all times, thereby enabling the recording of nanoscale information points beyond the optical diffraction limit and significantly enhancing the storage density of optical discs.
(2) By combining zoom-based layer jumping with lens group compensation for aberrations, ultra-high-density 3D data storage of up to hundreds of layers can ultimately be achieved.
(3) Compared to existing servo solutions applied to super-resolution 3D optical storage systems, the present invention does not require the addition of a separate servo light source. High-speed nanoscale focusing servo can be accomplished based on the dual-beam read/write system alone.
(4) The invention features a simple structure, ease of operation, and excellent compatibility with other servo control systems, such as tracking servo, rotational speed servo, and tilt servo.

### BRIEF DESCRIPTION OF THE DRAWINGS

FIG. 1 shows a schematic diagram of the overall architecture of the super-resolution 3D optical storage focusing servo device proposed in the present invention.

FIG. 2 shows a schematic diagram of a specific implementation of the focusing servo device of the present invention.

FIG. 3 shows a schematic diagram of the focused spots of the coaxial recording beam and the solid servo beam during the zoom-based layer-jumping process of the present invention.

FIG. 4 shows a workflow diagram of a super-resolution 3D optical storage zoom-based layer-jumping method according to the present invention.

FIG. 5 shows a workflow diagram of a super-resolution 3D optical storage focusing servo method according to the present invention.

Reference numbers in the figures refer to the following structures:
001—Super-Resolution Optical Disc; 002—M-th Information Recording Layer; 003—N-th Information Recording Layer; 004—Servo Guiding Layer; 10—Light Source Shaping Module; 100—Light Source Unit; 101—First Light Source; 102—Second Light Source;
200—Shaping Unit; 201—First Collimating Lens; 202—Second Collimating Lens; 203—Beam Splitter; 204—Half-Wave Plate; 205—First Quarter-Wave Plate; 206—Phase Plate; 207—First Reflector; 208—Polarizing Beam Splitter;
301—Solid Excitation Beam; 302—Hollow Inhibition Beam; 303—Solid Servo Beam;
40—Beam Combining Module; 401—First Focusing Lens; 402—Second Focusing Lens; 403—First Compensating Lens; 404—Second Compensating Lens; 405—First Dichroic Mirror; 406—Second Dichroic Mirror; 407—Second Reflector;
50—Zoom Layer-Selection Module; 501—Third Focusing Lens; 502—Fourth Focusing Lens; 503—Third Compensating Lens; 504—Fourth Compensating Lens; 505—Recording Objective Lens; 506—Second Quarter-Wave Plate; 507—Servo Objective Lens;
60—Drive Control Module; 601—First Displacement Actuator; 602—Second Displacement Actuator; 603—Third Displacement Actuator; 604—Fourth Displacement Actuator; 605—Fifth Displacement Actuator; 606—Controller; 607—Spindle Motor;
70—Recording Signal Detection Module; 701—First Filter; 702—Fifth Focusing Lens; 703—First Optical Fiber; 704—First Photodetector;
80—Servo Signal Detection Module; 801—Second Filter; 802—Astigmatic Lens; 803—Second Optical Fiber; 804—Second Photodetector.

### DETAILED DESCRIPTION OF THE INVENTION

The present invention is described below through specific embodiments. Those skilled in the art can easily understand other advantages and effects of the invention from the content disclosed in this specification.

It should be noted that the structures, proportions, sizes, etc. shown in the drawings of this specification are intended solely to complement the content disclosed in the specification for the understanding and reference of those skilled in the art. They are not intended to impose limitations on the conditions under which the invention may be implemented and therefore hold no substantive technical significance. Any modifications to the structures, changes in proportional relationships, or adjustments to sizes shall remain within the scope of the technical content disclosed by the present invention, provided that they do not affect the intended effects and objectives achievable by the invention. Furthermore, terms such as “upper,” “lower,” “left,” “right,” “center,” and “a” or “an” cited in this specification are used merely for clarity of description and are not intended to limit the scope within which the invention may be implemented. Any changes or adjustments to these relative relationships, provided that they do not substantially alter the technical content, shall also be considered within the scope of the invention.

A further detailed description is provided below in conjunction with the accompanying drawings.

In the following embodiments, a super-resolution optical disc is selected as the super-resolution 3D optical storage medium.

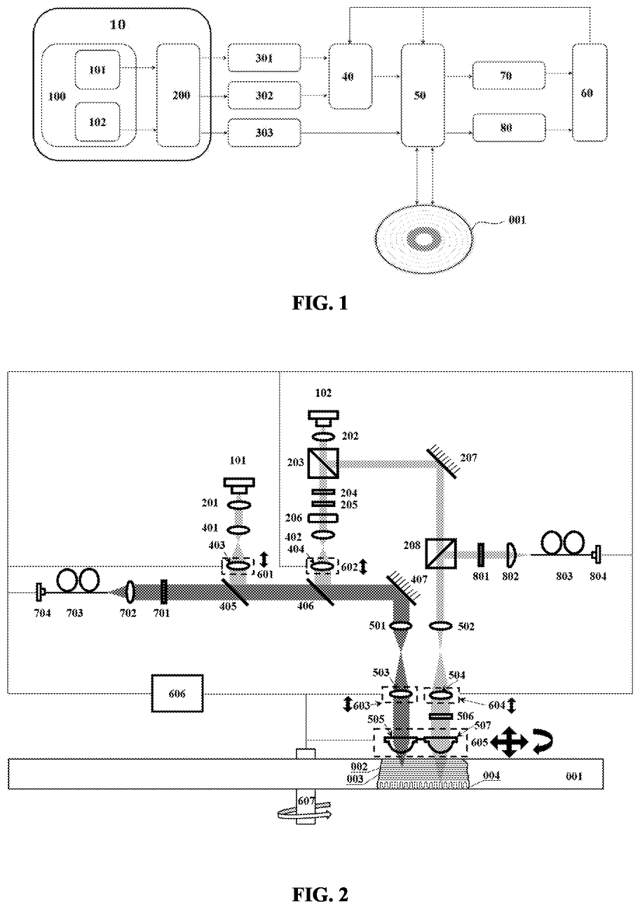

The overall architecture of the super-resolution 3D optical storage focusing servo device proposed in the present invention is shown in FIG. 1. The device of the present invention is suitable for super-resolution 3D optical storage media. The entire device comprises, or alternatively consists of, six main modules: a light source shaping module 10, a beam combining module 40, a zoom layer-selection module 50, a drive control module 60, a recording signal detection module 70, and a servo signal detection module 80.

The light source shaping module 10 comprises a light source unit 100 and a shaping unit 200.

The super-resolution 3D optical storage focusing servo device of the present invention can be applied to various optical storage systems based on dual-beam super-resolution principles, such as those utilizing stimulated emission depletion (STED), peripheral photoinhibition (PPI), triplet-triplet absorption (TTA), etc. The wavelengths of the dual beams used for recording are selected according to the specific principle and material properties. Therefore, the light source unit 100 comprises at least one laser source of a single wavelength or laser sources of different wavelengths, emitting two incident laser beams into the shaping unit 200.

The shaping unit 200 comprises at least a beam splitter, a collimating lens group, and a phase plate. Its function is to split and shape the two incident laser beams, thereby generating a solid excitation beam 301, a hollow inhibition beam 302, and a solid servo beam 303. The solid servo beam 303 has the same wavelength as either the solid excitation beam 301 or the hollow inhibition beam 302. That is, the solid servo beam 303 shares the same laser source with the solid excitation beam 301, or shares the same laser source with the hollow inhibition beam 302.

The beam combining module 40 comprises at least a dichroic mirror, which is configured to combine the solid excitation beam 301 and the hollow inhibition beam 302, after which they are jointly incident on the zoom layer-selection module 50.

The zoom layer-selection module 50 comprises at least a compensating lens and an objective lens, configured to control the axial position of the focused spot.

The drive control module 60 comprises at least a displacement actuator and a controller. It drives the motion of the zoom layer-selection module 50 to co-focus the solid excitation beam 301 and the hollow inhibition beam 302 onto a selected information recording layer of the super-resolution optical disc 001, while focusing the solid servo beam 303 onto a servo guiding layer of the super-resolution optical disc 001.

The recording signal detection module 70 comprises at least a filter and a photodetector, configured to detect the fluorescence signal generated by the solid excitation beam 301 and the hollow inhibition beam 302 in the information recording layer.

The servo signal detection module 80 comprises at least a filter, an astigmatic lens, and a photodetector, and is configured to monitor the servo reflection signal generated by the reflection of the solid servo beam 303 from the servo guiding layer.

The above modules are connected via optical or electrical signals. Specifically, the light source unit 100 comprises two light sources, each emitting a laser beam. After passing through the shaping unit 200, three laser beams are obtained: a solid excitation beam 301, a hollow inhibition beam 302, and a solid servo beam 303. The solid excitation beam 301 and the hollow inhibition beam 302 are coupled into the zoom layer-selection module 50 via the beam combining module 40 and are focused onto a selected information recording layer of the super-resolution optical disc 001. They interact with the medium of the recording layer to produce a fluorescence signal, which is then detected by the recording signal detection module 70 through the zoom layer-selection module 50. The detection results are transmitted to the drive control module 60. Meanwhile, the solid servo beam 303 is focused by the zoom layer-selection module 50 onto the servo guiding layer of the super-resolution optical disc 001. After reflection, it passes through the zoom layer-selection module 50 again and is detected by the servo signal detection module 80, with the detection results also transmitted to the drive control module 60. The drive control module 60 calculates and issues commands based on the detection results to control the beam combining module 40 and the zoom layer-selection module 50, thereby achieving focus servo control.

Furthermore, since the super-resolution 3D optical storage system comprises both writing and reading functions, when only the writing function is used, the system can be regarded as a super-resolution 3D laser direct writing system. When only the reading function is used, it can be considered a super-resolution 3D microscopic imaging system. Therefore, the present invention can also be applied to the fields of super-resolution 3D laser direct writing focus servo and super-resolution 3D microscopic imaging focus servo.

FIG. 2 illustrates one embodiment of the focus servo device of the present invention. As shown in FIG. 2, the super-resolution optical disc suitable for reading and writing has a multilayer structure, comprising multiple recording layers and a servo guiding layer located beneath them. The recording layers comprise materials that have the properties of aggregation-induced emission dye-doped photoresistance with a thickness of greater than 100 μm. They can be modulated by dual beams to generate nanoscale information points emitting fluorescence with dimensions beyond the optical diffraction limit, while exhibiting high transparency and uniformity. To achieve ultra-high-density multilayer storage, the recording layer is designed to comprise multiple information recording layers (e.g., the M-th information recording layer 002 and the N-th information recording layer 003). The bottom layer of the super-resolution optical disc 001 comprises a servo guiding layer 004 with a spiral groove structure, the surface of which is coated with a reflective material.

For information writing on the super-resolution optical disc, two light sources with wavelengths λ₁ and λ₂ are employed. The laser with wavelength λ₁ induces a photopolymerization effect in the focused area of the recording layer, while the laser with wavelength λ₂ inhibits the photopolymerization effect in the same area.

The laser emitted from the first light source 101 with wavelength λ₁ passes through the first collimating lens 201 to form a solid excitation beam. The laser emitted from the second light source 102 with wavelength λ₂ passes through the second collimating lens 202 and the beam splitter 203, forming a first transmitted beam and a second transmitted beam. The first transmitted beam passes through a half-wave plate 204, a first quarter-wave plate 205, and a phase plate 206 to form a hollow inhibition beam with circular polarization and zero intensity at its center. The second transmitted beam passes through a first reflector 207 and a polarizing beam splitter 208 to form a solid servo beam with linear polarization (s-polarization).

The first dichroic mirror 405 reflects λ₁, while the second dichroic mirror 406 reflects λ₂ and transmits λ₁, which couples the solid excitation beam and the hollow inhibition beam into a common optical path. The first focusing lens 401 and the first compensating lens 403 jointly compensate for aberrations in the solid excitation beam, while the second focusing lens 402 and the second compensating lens 404 jointly compensate for aberrations in the hollow inhibition beam, which ensures that the solid excitation beam and the hollow inhibition beam are three-dimensionally aligned after being focused by the recording objective lens 505 during the writing process, achieving optimal performance for super-resolution 3D optical storage.

The coaxial recording beam formed by coupling the solid excitation beam and the hollow inhibition beam is reflected by the second reflector 407. It then passes through the third focusing lens 501 and the third compensating lens 503, which jointly compensate for aberrations in the coaxial recording beam, enabling it to be focused onto the M-th information recording layer 002 of the super-resolution optical disc 001 via the recording objective lens 505. During the exposure time, nanoscale information points are formed, completing the information writing process.

During the writing process on the super-resolution optical disc, factors such as disc wobble and eccentricity caused by high-speed rotation or external environmental vibrations can lead to deviations of the focal centers of the solid excitation beam and the hollow inhibition beam from the recording layer. It can easily result in erroneous writing or even loss of information. Therefore, nanoscale precision focus servo is required. The fourth focusing lens 502 and the fourth compensating lens 504 jointly compensate for aberrations in the s-polarized solid servo beam, allowing it to be focused onto the underlying servo guiding layer 004 of the super-resolution optical disc 001 via the second quarter-wave plate 506 and the servo objective lens 507. The servo guiding layer 004 has high reflectivity for the solid servo beam. After reflection, the beam passes through the second quarter-wave plate 506, at which point the reflected servo beam becomes p-polarized. As a result, it is separated from the emitted servo beam when passing through the polarizing beam splitter 208. After stray light is filtered out by the second filter 801, the beam is focused by the astigmatic lens 802 into the second optical fiber 803 and collected by the second photodetector 804. The second photodetector 804 is an avalanche photodiode quadrant photodetector, capable of amplifying and detecting the collected optical signal to generate a servo reflection signal. The signal is then input to the controller 606, which adjusts the fifth displacement actuator 605 (specifically a voice coil motor) to drive the servo objective lens 507 for axial movement, reducing the focus error to zero. Since the recording objective lens 505 is rigidly connected to the servo objective lens 507, the recording objective lens 505 also moves axially accordingly, achieving focus tracking servo.

For the information reading of the super-resolution optical disc, to ensure long-term reliability, two additional light sources with wavelengths λ₃ and λ₄ are employed. The laser with wavelength λ₃, when focused on a nanoscale information point, triggers an aggregation-induced emission effect, enhancing fluorescence intensity. Conversely, the laser with wavelength λ4 suppresses the aggregation-induced emission effect at the nanoscale information point. Lasers of wavelengths λ₃ and λ₄ do not generate fluorescence or produce only weak fluorescence in unrecorded regions.

The optical path for reading is largely consistent with that for writing. When the solid excitation beam of wavelength λ₃ and the hollow inhibition beam of wavelength λ₄ are focused onto the M-th information recording layer 002 of the super-resolution optical disc 001 via the recording objective lens 505, intense fluorescence signals are emitted from the recorded information point areas due to the aggregation-induced emission effect. These fluorescence signals pass through the recording objective lens 505, the third compensating lens 503, the third focusing lens 501, and the second reflector 407. Since both the second dichroic mirror 406 and the first dichroic mirror 405 transmit fluorescence signals while reflecting the hollow inhibition beam of wavelength λ₄ and the solid excitation beam of wavelength λ₃, respectively, the fluorescence signals are separated from the solid excitation and hollow inhibition beams. Subsequently, after filtering by the first filter 701 and focusing by the fifth focusing lens 702, only the fluorescence signals reach the first optical fiber 703 and are collected by the first photodetector 704. The optical fiber acts as a pinhole, with its input end positioned confocally with the system's focal point, which ensures that only fluorescence/reflected light emitted from the system's focal point reaches the first photodetector 704, while light from other illuminated areas is blocked as they are out of focus, and enhances the signal-to-noise ratio, avoids crosstalk from adjacent recorded points, and thereby completes the information reading process. Furthermore, during the reading process, the focus tracking servo remains operational to ensure accurate information retrieval.

During the disc reading/writing process, a spindle motor 607 controls the high-speed rotation of the disc. The controller 606 regulates the rotational speed of the spindle motor 607 based on the received servo reflection signal or fluorescence signal, ensuring more stable signal transmission and further enhancing the precision of the focus servo.

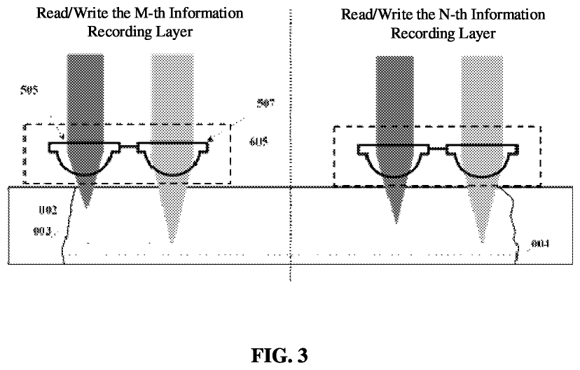

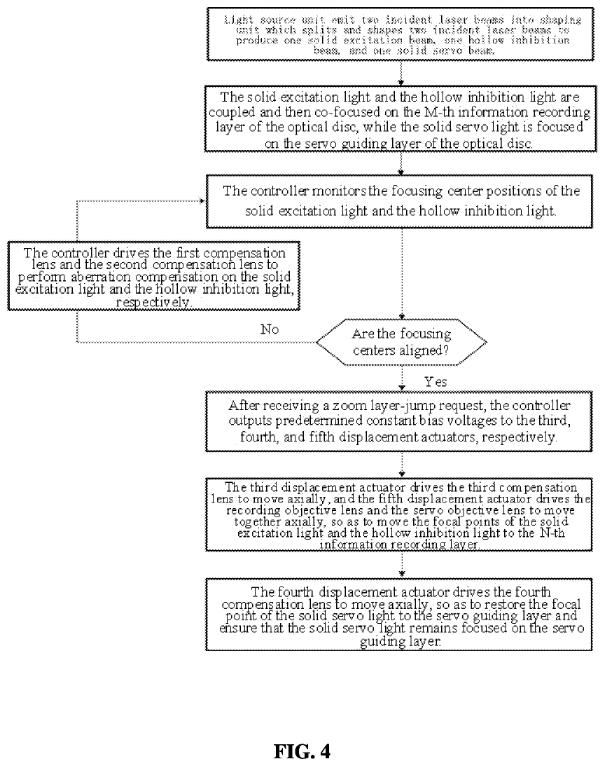

FIG. 3 illustrates the focused spots of the coaxial recording beam and the solid servo beam during the zoom-based layer-jumping process. First, based on the geometrical optical relationships among the first compensating lens 403, the second compensating lens 404, the third compensating lens 503, the recording objective lens 505, the fourth compensating lens 504, and the servo objective lens 507 in FIG. 2, the Newtonian formula and scanning calibration tests are applied to calculate and pre-store the corresponding relationships between the displacement of each compensating lens/objective lens and the focal point movement.

When reading/writing the M-th information recording layer 002, the coaxial recording beam composed of the solid excitation beam and the hollow inhibition beam is focused by the recording objective lens 505 onto the M-th information recording layer 002 of the super-resolution optical disc 001, exciting a fluorescence signal that surpasses the diffraction limit. This signal is collected by the first photodetector 704 and converted into a recording signal. Meanwhile, the solid servo beam is focused by the servo objective lens 507 onto the servo guiding layer 004 beneath the super-resolution optical disc 001. The reflected light signal is collected by the second photodetector 804 and converted into a servo reflection signal. Both the first photodetector 704 and the second photodetector 804 are connected to the controller 606, which contains a control algorithm. By analyzing the signals, the controller calculates the focal center positions of the solid excitation beam and the hollow inhibition beam. If a deviation between their centers is detected, the controller, based on the received fluorescence signal, controls the first displacement actuator 601 to drive the first compensating lens 403 for axial movement and the second displacement actuator 602 to drive the second compensating lens 404 for axial movement. Axial movement of the first compensating lens 403 compensates for aberrations in the solid excitation beam, while axial movement of the second compensating lens 404 compensates for aberrations in the hollow inhibition beam until their focal centers are aligned.

During high-speed rotation of the super-resolution optical disc, disc wobble, warpage, and other factors may cause the focused spot of the coaxial recording beam and the focused spot of the solid servo beam to deviate from their respective intended positions. The controller 606 continuously monitors the servo reflection signal and outputs focus error compensation commands to control the fifth displacement actuator 605. This drives both the recording objective lens 505 and the servo objective lens 507 for axial movement, reducing the focus error to zero and achieving focus tracking servo on the M-th information recording layer 002.

Upon receiving a request to zoom to the N-th information recording layer 003, the controller 606 applies an additional constant bias voltage to the fifth displacement actuator 605 while it continues to receive focus error compensation signals, thereby shifting the focal point of the coaxial recording beam to the N-th information recording layer 003. Simultaneously, the third displacement actuator 603 and the fourth displacement actuator 604 are each loaded with a constant bias voltage to drive the third compensating lens 503 and the fourth compensating lens 504 for axial movement, compensating for aberrations and ensuring that the solid servo beam is refocused by the servo objective lens 507 onto the servo guiding layer 004 beneath the super-resolution optical disc 001. The controller 606 continuously monitors the focal center positions of the solid excitation beam and the hollow inhibition beam, as well as the servo reflection signal, repeating the above process.

Additionally, during information writing, not only is user data recorded on the super-resolution optical disc 001, but the location information of this data on the disc, comprising layer and sector details, is also recorded. This facilitates rapid retrieval of the required data from the super-resolution optical disc 001 during reading.

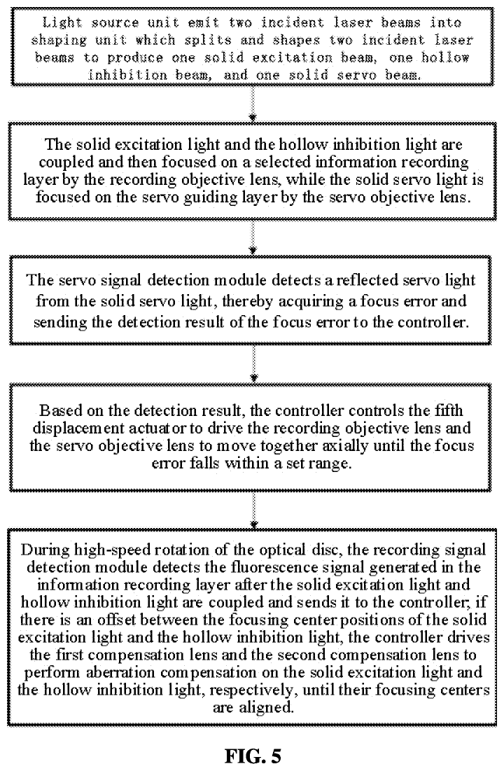

FIG. 4 shows the workflow diagram of a super-resolution 3D optical storage zoom-based layer-jumping method according to the present invention. It mainly comprises the following steps:
Step 1: The light source unit emits laser beams, which are split and shaped by the shaping unit to generate a solid excitation beam, a hollow inhibition beam, and a solid servo beam.
Step 2: The solid excitation beam and the hollow inhibition beam are coupled and co-focused onto the M-th information recording layer of the optical disc, while the solid servo beam is focused onto the servo guiding layer of the optical disc.
Step 3: The controller monitors the focal center positions of the solid excitation beam and the hollow inhibition beam. If any offset is detected, the controller drives the first compensating lens and the second compensating lens to perform aberration compensation for the solid excitation beam and the hollow inhibition beam, respectively, until their focal centers are aligned.
Step 4: Upon receiving a zoom layer-jump request, the controller outputs pre-set constant bias voltages to the third displacement actuator, the fourth displacement actuator, and the fifth displacement actuator, respectively.
Step 5: The third displacement actuator drives the third compensating lens for axial movement, while the fifth displacement actuator drives the recording objective lens and the servo objective lens for coordinated axial movement, shifting the focal points of the solid excitation beam and the hollow inhibition beam to the N-th information recording layer.
Step 6: The fourth displacement actuator drives the fourth compensating lens for axial movement, restoring the focal point of the solid servo beam to the servo guiding layer, ensuring that the solid servo beam remains focused on the servo guiding layer.

Through the above steps, the zoom-based layer jumping from the M-th information recording layer to the N-th information recording layer is completed. Repeating steps 1 to 6 enables multi-layer recording.

FIG. 5 shows the workflow diagram of a super-resolution 3D optical storage focusing servo method according to the present invention. It mainly comprises the following steps:
Step 1: The light source unit emits laser beams, which are split and shaped by the shaping unit to generate a solid excitation beam, a hollow inhibition beam, and a solid servo beam.
Step 2: The solid excitation beam and the hollow inhibition beam are coupled and focused onto the selected information recording layer via the recording objective lens, while the solid servo beam is focused onto the servo guiding layer via the servo objective lens.
Step 3: The servo signal detection module detects the reflected servo beam of the solid servo beam to obtain the focus error and sends the detection result of this focus error to the controller.
Step 4: Based on the detection result, the controller controls the fifth displacement actuator to drive the recording objective lens and the servo objective lens for coordinated axial movement until the focus error falls within the set range.
Step 5: During high-speed rotation of the optical disc, the recording signal detection module detects the fluorescence signal generated by the coupled solid excitation beam and hollow inhibition beam in the information recording layer and sends it to the controller. If an offset exists between the focal centers of the solid excitation beam and the hollow inhibition beam, the controller drives the first compensating lens and the second compensating lens to perform aberration compensation for the solid excitation beam and the hollow inhibition beam, respectively, until their focal centers are aligned.

Herein, the fluorescence signal serves as a feedback signal to indicate whether an offset exists between the focal centers of the solid excitation beam and the hollow inhibition beam.

Through the above operations, during high-speed rotation of the optical disc, the focal centers of the solid excitation beam and the hollow inhibition beam remain aligned and positioned on the selected information recording layer, thereby achieving focus servo.

In summary, the super-resolution 3D optical storage focusing servo device and its servo method of the present invention utilize the servo reflection signal reflected from a single servo guiding layer to control the axial movement of the objective lens. Combined with the method of lens group compensation for aberrations, zoom-based layer jumping is achieved. During the reading and writing processes, the focal points of the solid excitation beam and the hollow inhibition beam can be adjusted in real time, ensuring that the dual beams remain three-dimensionally aligned at all times. This enables precise ultra-high-density 3D optical data storage of up to hundreds of layers, significantly enhancing the storage density of optical discs. Furthermore, through beam splitting and multiplexing, no additional servo light source is required. The present invention features a simple structure, ease of operation, and effectively overcomes various drawbacks of existing technologies, offering high industrial utility value.

The above embodiments are merely illustrative of the principles and effects of the present invention and are not intended to limit the invention. Any person skilled in the art may modify or alter the above embodiments without departing from the spirit and scope of the present invention. Therefore, all equivalent modifications or changes made by those of ordinary skill in the art without departing from the spirit and technical concepts disclosed in the present invention shall fall within the scope of the claims of the present invention.

The super-resolution three-dimensional optical storage focusing servo device of the present invention requires no additional servo light source and the dual-beam foci are adjusted in real time to maintain 3D alignment, thus enabling recording beyond the diffraction limit and increasing storage density. Combined with lens group compensation for aberration and zoom layer jumping, the device achieves ultra-high-density storage of hundreds of layers. The device features a simple structure, convenient operation, and good compatibility. It is applicable in the field of super-resolution 3D optical storage and holds broad application prospects.

We claim:

1. A focusing servo device for super-resolution 3D optical storage, comprising:
a light source shaping module configured to form a solid excitation light, a hollow inhibition light, and a solid servo light,
a beam combining module configured to combine the solid excitation light and the hollow inhibition light into a coaxial recording light with coincident centers,
a zoom layer selection module configured to control the axial position of the focused spot of the coaxial recording light and the axial position of the focused spot of the solid servo light,
a servo signal detection module configured to receive a reflected servo light generated after the solid servo light is reflected by a servo guiding layer and convert the reflected servo light into a servo reflection signal for monitoring,
a recording signal detection module configured to detect a fluorescence signal generated by the coaxial recording light in an information recording layer, and
a drive control module configured to receive the servo reflection signal and the fluorescence signal, drive the beam combining module based on the fluorescence signal to perform aberration compensation on the solid excitation light and the hollow inhibition light until their focusing centers are aligned, and
drive objective lenses comprised in the zoom layer selection module to move axially based on the servo reflection signal, so as to focus the solid servo light on a servo guiding layer of an optical storage medium and focus the coaxial recording light on a selected information recording layer of the optical storage medium,
wherein the light source shaping module comprises a light source unit and a shaping unit; the light source unit comprises at least a single-wavelength laser light source or laser light sources of different wavelengths, emitting two incident laser beams into the shaping unit; the shaping unit splits and shapes the two incident laser beams to generate one solid excitation light, one hollow inhibition light, and one solid servo light.

2. The focusing servo device according to claim 1, wherein the zoom layer selection module comprises a recording objective lens and a servo objective lens,
the recording objective lens is configured to control the axial position of the focused spot of the coaxial recording light, and the servo objective lens is configured to control the axial position of the focused spot of the solid servo light,
the axial movement of the servo objective lens can be linked to or trigger the corresponding axial movement of the recording objective lens in a timely manner, and
the drive control module drives the servo objective lens to move axially according to the servo reflection signal, while linking or triggering the axial movement of the recording objective lens.

3. The focusing servo device according to claim 1, wherein the numerical aperture of the objective lenses in the zoom layer selection module is not less than 0.65.

4. The focusing servo device according to claim 2, wherein the recording objective lens and the servo objective lens are rigidly connected.

5. The focusing servo device according to claim 1, wherein the shaping unit comprises a beam splitter, a collimating lens group, and a phase plate;
the beam splitter is configured to split one incident laser beam into at least two beam paths;
the collimating lens group is configured to collimate each beam path;
the phase plate is configured to perform phase modulation on one collimated beam path to form the hollow inhibition light;
the beam combining module comprises a dichroic mirror, which is configured to combine beams from different paths into a single beam path;
the zoom layer selection module comprises compensation lenses and objective lenses;
the compensation lenses are configured to perform focusing adjustment on each beam path, and the objective lenses are configured to adjust the axial position of the focused spot of each beam path;
the drive control module comprises displacement actuators and a controller;
the controller is configured to receive signals and send commands to the displacement actuators, and the displacement actuators drive the zoom layer selection module and/or the beam combining module to perform precise adjustments according to the commands;
the recording signal detection module comprises a first filter and a first photodetector;
the first filter is configured to filter out unwanted light of specific wavelengths to ensure the purity of the fluorescence signal;
the first photodetector is configured to detect the fluorescence signal after passing through the first filter;
the servo signal detection module comprises a second filter, an astigmatic lens, and a second photodetector;
the second filter is configured to filter out unwanted light of specific wavelengths from the reflected servo light;
the astigmatic lens is configured to modulate the reflected servo light, such that when the focused spot of the coaxial recording light is on or deviates from the selected information recording layer, the spot shape formed on the second photodetector by the reflected servo light differs; and
the second photodetector is configured to detect the reflected servo light after passing through the second filter and the astigmatic lens, and convert the reflected servo light into the servo reflection signal for monitoring.

6. The focusing servo device according to claim 1, wherein the light source unit comprises a first light source (101) and a second light source (102);
the shaping unit comprises a first collimating lens (201), a second collimating lens (202), a beam splitter (203), a half-wave plate (204), a first quarter-wave plate (205), a phase plate (206), a first reflecting mirror (207), and a polarization beam splitter (208);
the beam combining module comprises a first focusing lens (401), a first compensation lens (403), a first dichroic mirror (405), a second dichroic mirror (406), a second focusing lens (402), a second compensation lens (404), and a second reflecting mirror (407);
the zoom layer selection module comprises a third focusing lens (501), a third compensation lens (503), a recording objective lens (505), a fourth focusing lens (502), a fourth compensation lens (504), a second quarter-wave plate (506), and a servo objective lens (507);
the drive control module comprises a controller (606), a first displacement actuator (601), a second displacement actuator (602), a third displacement actuator (603), a fourth displacement actuator (604), and a fifth displacement actuator (605);
the servo signal detection module comprises a second filter (801), an astigmatic lens (802), a second optical fiber (803), and a second photodetector (804);
a light beam output from the first light source (101) passes through the first collimating lens (201) to form the solid excitation light (301);
a light beam output from the second light source (102) enters the beam splitter (203) via the second collimating lens (202) and is split into a first transmitted light and a second transmitted light; the first transmitted light successively passes through the half-wave plate (204) and the first quarter-wave plate (205) and then enters the phase plate (206) to form the hollow inhibition light (302) with a first circular polarization state; the second transmitted light is directed by the first reflecting mirror (207) to enter the polarization beam splitter (208) and is transmitted through the polarization beam splitter (208) to form the solid servo light (303) with a first linear polarization state;
the solid excitation light (301) successively passes through the first focusing lens (401) and the first compensation lens (403) and enters the first dichroic mirror (405); it is reflected by the first dichroic mirror (405) to form a first reflected light, which then enters the second dichroic mirror (406) and is transmitted through the second dichroic mirror (406) to form a third transmitted light;
the hollow inhibition light (302) successively passes through the second focusing lens (402) and the second compensation lens (404) and enters the second dichroic mirror (406); it is reflected by the second dichroic mirror (406) to form a second reflected light;
the second reflected light and the third transmitted light are combined by the second dichroic mirror (406) and then reflected by the second reflecting mirror (407) to form a third reflected light;
the third reflected light successively passes through the third focusing lens (501), the third compensation lens (503), and the recording objective lens (505) and is incident on an M-th information recording layer (002) of the optical storage medium, where it excites and generates the fluorescence signal in the focused region;
the solid servo light (303) successively passes through the fourth focusing lens (502) and the fourth compensation lens (504) and is incident on the second quarter-wave plate (506), where it is converted into a fourth transmitted light with a second circular polarization state;
the fourth transmitted light passes through the servo objective lens (507) and is incident on the servo guiding layer (004) of the optical storage medium; it is reflected by the servo guiding layer (004) to form a fourth reflected light with a third circular polarization state;
the fourth reflected light passes through the servo objective lens (507) and is incident on the second quarter-wave plate (506); it passes through the second quarter-wave plate (506) and is converted into a fifth transmitted light with a second linear polarization state;
the fifth transmitted light successively passes through the fourth compensation lens (504) and the fourth focusing lens (502) and is incident on the polarization beam splitter (208); it is reflected by the polarization beam splitter (208) to form a fifth reflected light;
the fifth reflected light successively passes through the second filter (801), the astigmatic lens (802), and the second optical fiber (803) and reaches the second photodetector (804), wherein it is converted by the second photodetector (804) into the servo reflection signal;
the second photodetector (804) is connected to the controller (606);
the second photodetector (804) monitors the servo reflection signal and sends it to the controller (606); and
the controller (606), based on the received servo reflection signal, respectively controls in real time: the third displacement actuator (603) to drive the third compensation lens (503) to move axially, the fourth displacement actuator (604) to drive the fourth compensation lens (504) to move axially, and the fifth displacement actuator (605) to drive the recording objective lens (505) and the servo objective lens (507) to move together axially.

7. The focusing servo device according to claim 6, wherein the recording signal control module comprises a first filter (701), a fifth focusing lens (702), a first optical fiber (703), and a first photodetector (704);
the fluorescence signal, after being collected by the recording objective lens (505), successively passes through the third compensation lens (503) and the third focusing lens (501) and is incident on the second reflecting mirror (407); it is reflected by the second reflecting mirror (407) to form a sixth reflected light;
the sixth reflected light successively passes through the second dichroic mirror (406), the first dichroic mirror (405), the first filter (701), the fifth focusing lens (702), and the first optical fiber (703), and reaches the first photodetector (704);
the first filter (701) transmits the fluorescence signal and filters out the solid excitation light (301) and the hollow inhibition light (302);
the first photodetector (704) is connected to the controller (606);
the first photodetector (704) detects the fluorescence signal and sends it to the controller (606); and
the controller (606), based on the received fluorescence signal, respectively controls: the first displacement actuator (601) to drive the first compensation lens (403) to move axially, and the second displacement actuator (602) to drive the second compensation lens (404) to move axially.

8. The focusing servo device according to claim 6, wherein the first linear polarization state and the second linear polarization state are mutually perpendicular.

9. The focusing servo device according to claim 1, further comprising:
a spindle motor for controlling high-speed rotation of the optical storage medium,
wherein the drive control module controls a rotational speed of the spindle motor based on the received servo reflection signal or the fluorescence signal.

10. A focusing servo method for super-resolution 3D optical storage based on the focusing servo device according to claim 1, comprising:
forming a solid excitation light, a hollow inhibition light, and a solid servo light by using a light source shaping module;
combining the solid excitation light and the hollow inhibition light into a coaxial recording light with coincident centers by using a beam combining module;
focusing the coaxial recording light and the solid servo light on an M-th information recording layer and a servo guiding layer of an optical storage medium, respectively, by using a zoom layer selection module, wherein M is an integer;
monitoring a servo reflection signal generated after the solid servo light is reflected by the servo guiding layer, and sending the servo reflection signal to a drive control module, by using a servo signal detection module;
if the servo reflection signal is not within a set range, driving, by using the drive control module according to the servo reflection signal, a recording objective lens and a servo objective lens of the zoom layer selection module to move together axially until the servo reflection signal monitored by the servo signal detection module falls within the set range, thereby re-focusing the solid servo light on the servo guiding layer of the optical storage medium and re-focusing the coaxial recording light on the M-th information recording layer of the optical storage medium; wherein the recording objective lens is configured to control the axial position of the focused spot of the coaxial recording light, and the servo objective lens is configured to control the axial position of the focused spot of the solid servo light; and
detecting a fluorescence signal generated in the information recording layer by the coaxial recording light, and sending the fluorescence signal to the drive control module, by using a recording signal detection module; if there is an offset between focusing center positions of the solid excitation light and the hollow inhibition light, driving, by the drive control module according to the fluorescence signal, the beam combining module to perform aberration compensation on the solid excitation light and the hollow inhibition light until their focusing centers are aligned;
wherein the fluorescence signal serves as a feedback signal to indicate whether an offset exists between the focusing center positions of the solid excitation light and the hollow inhibition light.

11. The focusing servo method according to claim 10, wherein the drive control module comprises a controller, a first displacement actuator, and a second displacement actuator; based on the received fluorescence signal, the controller respectively controls: the first displacement actuator to drive a first compensation lens of the beam combining module to move axially, and the second displacement actuator to drive a second compensation lens of the beam combining module to move axially; and
wherein the aberration compensation for the solid excitation light is achieved by the axial movement of the first compensation lens; and the aberration compensation for the hollow inhibition light is achieved by the axial movement of the second compensation lens.

12. The focusing servo method according to claim 10, wherein after receiving a zoom layer-jump request, the drive control module drives a third compensation lens of the zoom layer selection module to move axially, and drives the recording objective lens and the servo objective lens to move together axially, so as to move focal points of the solid excitation light and the hollow inhibition light to an N-th information recording layer;
then, the drive control module drives a fourth compensation lens of the zoom layer selection module to move axially, so as to restore the focal point of the solid servo light to the servo guiding layer, and N is an integer, and N is not M.

13. The focusing servo method according to claim 12, wherein the drive control module comprises a controller, a third displacement actuator, a fourth displacement actuator, and a fifth displacement actuator; after receiving the zoom layer-jump request, the controller respectively outputs predetermined constant bias voltages to the third displacement actuator, the fourth displacement actuator, and the fifth displacement actuator; the third displacement actuator drives the third compensation lens to move axially, and the fifth displacement actuator drives the recording objective lens and the servo objective lens to move together axially, so as to move the focal points of the solid excitation light and the hollow inhibition light to the N-th information recording layer; then, the fourth displacement actuator drives the fourth compensation lens to move axially, so as to restore the focal point of the solid servo light to the servo guiding layer.
